(19) United States
(12) Patent Application Publication
(10) Pub. No.: US 2026/0279193 A1
(43) Pub. Date: Sep. 17, 2026

(54) Method of Processing Road Traffic Data Using a Generative Pre-trained Transformer (GPT)

(71) Applicant: Hong Kong Applied Science And Technology Research Institute Co., Ltd., Shatin (HK)

(72) Inventors: Ho Lung Hui, Kwai Chung (HK); Zhuojun Chen, Guangzhou (CN); Xinghua Zhu, Shenzhen (CN); Dongzhe Su, Shenzhen (CN)

(21) Appl. No.: 19/077,600

(22) Filed: Mar. 12, 2025

(51) Int. Cl. G08G 1/01

(52) U.S. Cl. CPC G08G 1/0133

(57) ABSTRACT

A method of processing road traffic data using a generative pre-trained transformer (GPT). The method comprises receiving a set of input tensors as an input to the GPT, each input tensor comprising multi-modality traffic data for one or more participants of a traffic scene, the GPT having been pre-trained on multi-modality traffic data. The method includes the GPT computing traffic features of the traffic scene based on observed traffic states; and the GPT predicting one or more future traffic states from the computed traffic features.

### FIELD OF THE INVENTION

The invention relates to a method of processing road traffic data using a generative pre-trained transformer (GPT). The invention also relates to traffic data modelling. In particular, the invention relates to an algorithm that unifies the modelling of spatial-temporal relevant traffic data, enabling it to capture features of seen agents in a global aspect, with better capture of multi-agent interaction in urban traffic environments.

### BACKGROUND OF THE INVENTION

Traffic scenarios or scenes can be described as data in extensively varying modalities. For example, every vehicle has its position, heading and velocity in a spatial-temporal space. A road junction can be described using traffic flow, traffic light states, with images from cameras and/or point cloud from Light Detection and Ranging (LiDAR) sensors. Understanding and modelling traffic scenarios requires modelling many significant types of data to answer the query of interest.

An end-to-end optimized model is a method of data understanding that takes an input and returns a desired output using only a deep learning model, without any other processing between the inputs and outputs. For example, for a decision-making task of a self-driving vehicle, the state of each vehicle and that of its surrounding environment are taken as the inputs, processed by a deep neural network, and the outputs comprise the commands for the vehicle to perform. The only processing module is the neural network comprising the deep learning model.

A pre-trained model refers to a model that is already trained with large datasets. Such a model is ready to use with an input sample set that comprises samples from the scene dataset, while also being capable of being fine-tuned using a new dataset. Fine-tuning a pretrained model allows the model to more quickly handle tasks and to handle new tasks. The pre-trained model can be implemented as a GPT.

Traditional traffic models, however, have limitations at capturing complex agent interactions, as they typically interpret traffic scenarios as isolated instances in time. Such models are trained with large amounts of labelled data. Additional effort is required when only large amount of raw data is available. Therefore, there is a need to implement an algorithm for pre-training on a large traffic model, minimizing the work to be done on downstream task solutions and unseen case adaptations.

Therefore, there is a need, among other things, to implement a novel method for processing road traffic data, for predicting future traffic states for one or more elements or participants of a traffic scene, and for training a GPT for processing road traffic data.

### OBJECTS OF THE INVENTION

An object of the invention is to mitigate or obviate to some degree one or more problems associated with known methods of processing road traffic data for predicting future traffic states for one or more participants of a traffic scene.

The above object is met by the combination of features of the main claims; the sub-claims disclose further advantageous embodiments of the invention.

Another object of the invention is to provide a novel method and system of processing road traffic data using a GPT.

Yet another object of the invention is to provide a novel method of training a GPT for processing road traffic data.

One skilled in the art will derive from the following description other objects of the invention. Therefore, the foregoing statements of object are not exhaustive and serve merely to illustrate some of the many objects of the present invention.

### SUMMARY OF THE INVENTION

The invention provides an algorithm that unifies the modelling of spatial-temporal relevant traffic data, enabling it to capture features of seen agents in a global aspect with better capture of multi-agent interaction in urban traffic environments.

In a first main aspect, the invention provides a method of processing road traffic data using GPT, the method comprising: receiving a set of input tensors as an input to the GPT, each input tensor comprising multi-modality traffic data for one or more participants of a traffic scene, the GPT having been pre-trained on multi-modality traffic data; the GPT computing traffic features of the traffic scene based on observed traffic states; and the GPT predicting one or more future traffic states from the computed traffic features.

In a second main aspect, the invention provides a computer-implemented system for predicting future traffic states for one or more participants of a traffic scene, the system comprising: an input for receiving a set of input tensors to the GPT, each input tensor comprising multi-modality traffic data for one or more participants of the traffic scene, wherein the GPT is pre-trained on multi-modality traffic data and the GPT is configured to compute traffic features of the traffic scene based on observed traffic states of the traffic scene and to predict one or more future traffic states from the computed traffic features.

In a third main aspect, the invention provides a method of training a GPT for processing road traffic data, the GPT comprising an input for receiving a set of input tensors to the GPT, each input tensor comprising multi-modality traffic data for one or more participants of the traffic scene, the GPT being configured to compute traffic features of the traffic scene based on observed traffic states of the traffic scene and to predict one or more future traffic states from the computed traffic features, the training method using: a two-stage element tokenization process to convert the multi-modality traffic data into set tokens; or using a set encoder to convert a set of element tokens into a set token using a surrogate reconstruction process.

In a fourth main aspect, the invention provides a non-transitory computer-readable medium storing machine-readable instructions, wherein, when the machine-readable instructions are executed by a processor, they configure the processor to implement any of the methods of the first and third main aspects of the invention.

The summary of the invention does not necessarily disclose all the features essential for defining the invention; the invention may reside in a sub-combination of the disclosed features.

The foregoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 illustrates a traffic scenario or traffic scene at different traffic state time steps;

FIG. 2 provides a comparison of the well-known GPT “ChatGPT™” and the GPT of the invention;

FIG. 3 illustrates a flow diagram of an embodiment of the GPT of the invention;

FIG. 4 illustrates a flow diagram of a second embodiment of the GPT of the invention;

FIG. 5 illustrates in more detail the flow diagram of FIG. 4;

FIG. 6 illustrates two stage tokenization in accordance with the flow model of the invention;

FIG. 7 illustrates set encoding in accordance with the flow model of the invention;

FIG. 8 illustrates a Vector Quantized-Variational Autoencoder (VQ-VAE) for quantization of tokens in accordance with the flow model of the invention;

FIG. 9 illustrates a traffic scene where sampling of elements is performed for surrogate reconstruction;

FIG. 10 illustrates surrogate reconstruction in accordance with the flow model of the invention;

FIG. 11 illustrates in more detail the surrogate reconstruction of FIG. 10; and

FIG. 12 illustrates anomaly detection in accordance with the flow model of the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the drawings may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The following description describes implementation of the present invention in a 5G communications network by way of example, but without limitation to implementation of the invention in suitable communications networks.

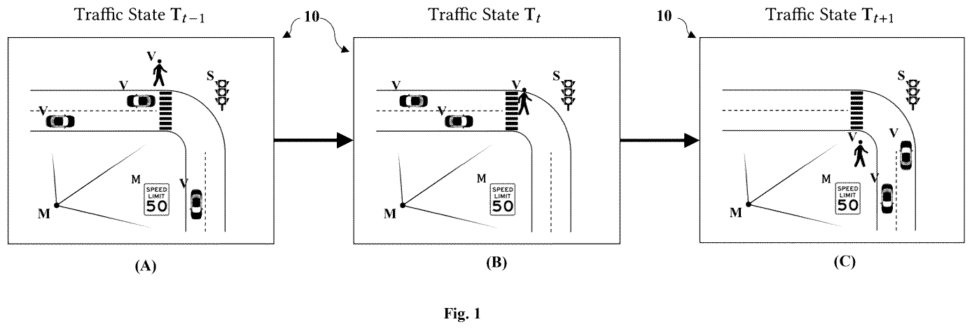

Referring to FIG. 1, which illustrates a traffic scenario or traffic scene 10 at different traffic state time steps, the GPT of the invention aims to predict the future states of, for example, vehicles, pedestrians, and traffic signals based on their historical states and the road network, e.g., the traffic scene 10, they occupy. It will be understood that the number of input participants in the traffic scene 10 may vary as the traffic scene 10 is a dynamic environment.

Image (A) of FIG. 1 shows the state of the traffic scene 10 in a time step (Tₜ-1) prior to the current time step (Tₜ) shown in image (B). Images (A) and (B) represent the historical states of the traffic scene 10. Image (C) shows the state of the traffic scene 10 in a next, future time step following the current time step. Image (C) represents the future state of the traffic scene 10 which the GPT of the invention is configured to predict or determine.

In FIG. 1: V is the direction or trajectory of vehicles and pedestrians; S is the states of traffic signals; and M comprises information about the road network of the traffic scene 10 such as lane markings, traffic rules of the map of the road network, etc.

The vehicles, pedestrians, and traffic signals can be considered as traffic participants or elements in the traffic scene 10. Every traffic participant can be modeled as an agent with states and behaviors. The state of agent i at time t can be formally written as:

$${V}_{i , t} = \{ {p}_{i , t} , {v}_{i , t} , {a}_{i , t} , {h}_{i , t} , ... \}$$

where pᵢ is position, vᵢ is velocity, aᵢ is acceleration, and hᵢ is heading or trajectory of agent i.

The states of all N agents can be represented as a finite set:

$${V}_{t} = \{ {V}_{1 , t} , {V}_{2 , t} , ... , {V}_{N , t} \}$$

The environment is represented as a combination of static map elements or participants and dynamic elements or participants:

$${E}_{t} = \{ M , {S}_{t} \}$$

where M comprises static map elements, and St comprises the states of the dynamic elements at time t.

In the generative traffic flow model of the invention, the traffic system at time step t can be conceptualized as Tₜ={Vₜ,Eₜ}, where:
Vₜ is the set of all active agents within the traffic environment at time t; and
Eₜ is the state of the environment, including static map elements and the states of dynamic elements at time t.

A core objective of the generative traffic flow model of the invention is to model the conditional distribution of the future traffic state given its historical state:

$$P ( {T}_{t + 1} \vert {T}_{1} , {T}_{2} , ... , {T}_{t} ) .$$

The generative traffic flow model models the state evolution of each agent conditioned on neighboring agents' states, its own past state, and the traffic rules of the traffic scene 10:

$$P ( {V}_{i , t} \vert {T}_{1} , {T}_{2} , ... {T}_{t} , {\{ {E}_{t + 1} , {V}_{j , t + 1} \}}_{j \neq i} ) .$$

The environment state Eₜ₊₁ is conditioned on the past states of the environment and current states of agents:

$$P ( {E}_{t + 1} \vert {T}_{1} , {T}_{2} , ... , {T}_{t} , {V}_{t + 1} ) .$$

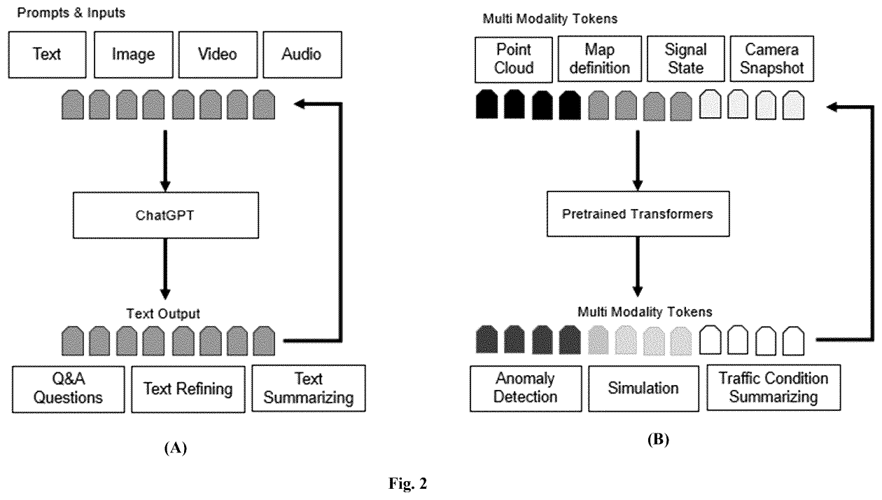

In FIG. 2, image (A) illustrates the well-known GPT “ChatGPT™” having an input to the GPT for receiving, for example, “text”, “image”, “video”, and “audio”. The output of the GPT comprises text which can represent various types of output such as, for example, questions and answers, text refining, text summarizing, etc. It will be noted that the GPT has one or more inputs and one or more outputs with the transformer of the GPT receiving the inputs and creating the outputs from the inputs without requiring any bilateral or other processing, etc.

A GPT is a type of large language model (LLM) comprising an artificial neural network that is used in natural language processing by machines. It is based on transformer deep learning architecture and typically pre-trained on large datasets of unlabelled text, and able to generate novel human-like content.

In a similar manner image (A) of FIG. 2, the GPT of the invention, illustrated in image (B) of FIG. 2, has one or more inputs and one or more outputs. The inputs are processed by the transformer to create the outputs. No other processing entity is required. The GPT of the invention differs from the GPT of image (A) in that the inputs are configured to receive multi-modality data tokens and the outputs are configured to output multi-modality data tokens. The input multi-modality data tokens may represent inputs including, for example, point cloud data from the traffic scene 10, data defining traffic signal states for the traffic scene 10, image data from cameras within the traffic scene 10, and road network layout and map data for the traffic scene 10. The output multi-modality data tokens may be used to not only provide predicted future traffic states for the traffic scene 10 but to also perform tasks such as anomaly detection in the traffic scene 10 to identify abnormal traffic scenarios, to simulate future traffic states of the traffic scene 10, and to summarize traffic conditions within the traffic scene 10. It will be understood that the traffic scene 10 comprises a dynamic environment in which traffic states are continuously changing. Consequently, the input multi-modality data tokens may comprise a time series of input multi-modality data tokens and likewise the output multi-modality data tokens may comprise a time series of output multi-modality data tokens as will be more fully explained hereinafter.

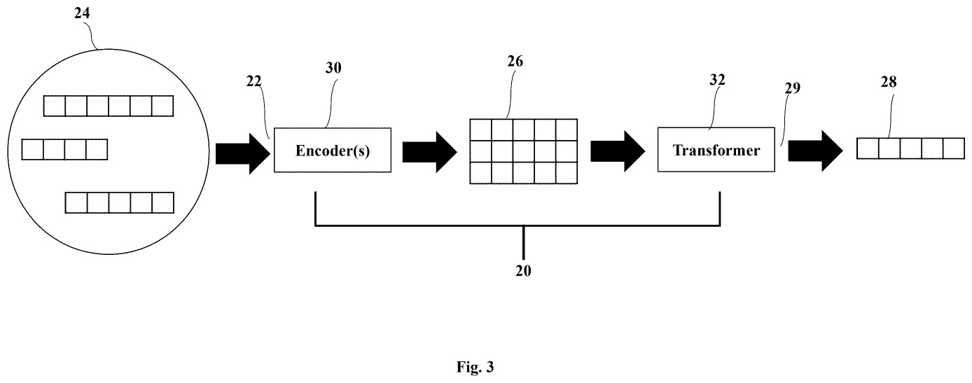

FIG. 3 illustrates a flow diagram of an embodiment of the GPT 20 of the invention. An input 22 of the GPT 20 is configured to receive a set of input tensors 24, each input tensor comprising multi-modality traffic data for one or more participants or elements of the traffic scene 10. The GPT 20 computes traffic features 26 of the traffic scene 10 based on observed traffic states of the traffic scene 10. The GPT 20 then predicts or determines one or more future traffic states 28 for the traffic scene 10 from the computed traffic features 26. The future traffic states 28 are communicated from an output 29 of the GPT 20.

In a first embodiment of the method of using the GPT 20, the GPT 20 is utilized to process road traffic data to predict the one or more future traffic states of the traffic scene 10. In this embodiment, the GPT 20 is pre-trained on multi-modality traffic data. In a second embodiment of the method of using the GPT 20, the GPT 20 is trained on multi-modality traffic data to prepare the GPT 20 for use in the first embodiment of the method.

The one or more participants or elements of the traffic scene 10 comprise any one or any combination of: vehicles within the traffic scene 10; pedestrians within the traffic scene 10; and traffic signals within the traffic scene 10.

The multi-modality traffic data comprises any of: states of the traffic signals within the traffic scene 10; position of vehicles and/or pedestrians within the traffic scene 10; speed of vehicles and/or pedestrians within the traffic scene 10; direction or trajectory of vehicles and/or pedestrians within the traffic scene 10; and information describing road network parameters of the traffic scene 10. The road network parameters of the traffic scene 10 may include information describing any of: lane layout of the traffic scene 10; and traffic rules of the traffic scene 10.

Referring again to FIG. 3, the pre-trained GPT 20 employs one or more encoders 30 which convert the multi-modality traffic data into tokens. The pre-trained GPT 20 employs a decoder-only transformer 32 which determines a next token from the tokens converted from the multi-modality traffic data, the next token comprising a predicted future traffic state for one of the elements of the traffic scene 10. The computed traffic features 26 of the traffic scene 10 comprise a time series of sets of tokens converted from the multi-modality traffic data by the one or more encoders. In a transformer model, an “encoder” refers to the part of the encoder that takes individual input tokens and transforms them into numerical representations (embeddings) by incorporating contextual information from the entire sequence through the multi-head self-attention mechanism, essentially creating a richer understanding of each token within the context of the whole input sequence.

A decoder-only transformer comprises a neural network architecture used in natural language processing tasks. It typically combines with an encoder to process input text and generate output text. It has multiple layers of self-attention and feed-forward neural networks. An attention function maps a query and a set of key-value pairs to an output, where the query, keys, values, and output are all vectors. The output is computed as a weighted sum of the values, where the weight assigned to each value is computed by a compatibility function of the query with a corresponding key. The input to a self-attention layer comprises a batch of token sequences, where each token in the sequence is represented with a vector. Decoder-only transformers use a variant of self-attention called masked (or causal) self-attention. Masked self-attention modifies the underlying attention pattern by “masking out” tokens that follow a given token within the sequence. The decoder-only transformer architecture is comprised of several “blocks” with identical structure that are stacked in sequence. Within each of these blocks, there are two primary components: masked, multi-headed self-attention; and a feed-forward transformation.

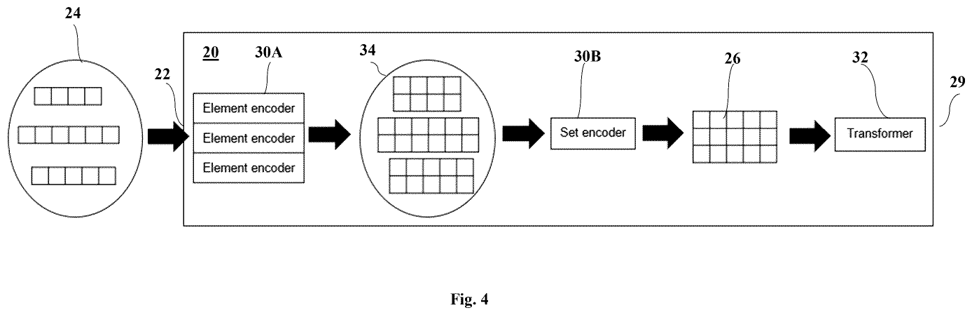

FIG. 4 illustrates a flow diagram of a second embodiment of the GPT 20 of the invention. This embodiment differs from the embodiment of FIG. 3 in that the GPT 20 includes a set encoder 30B to convert a set of element tokens 34 from the one or more element encoders 30A into a set token of fixed length. In this embodiment, the decoder-only transformer 32 determines a next token from a sequence of set tokens, the next token again comprising a predicted future traffic state for one of the elements of the traffic scene 10. The computed traffic features 26 of the traffic scene 10 comprise a time series of sets of element tokens converted from the multi-modality traffic data by the one or more element encoders 30A and the set encoder 30B.

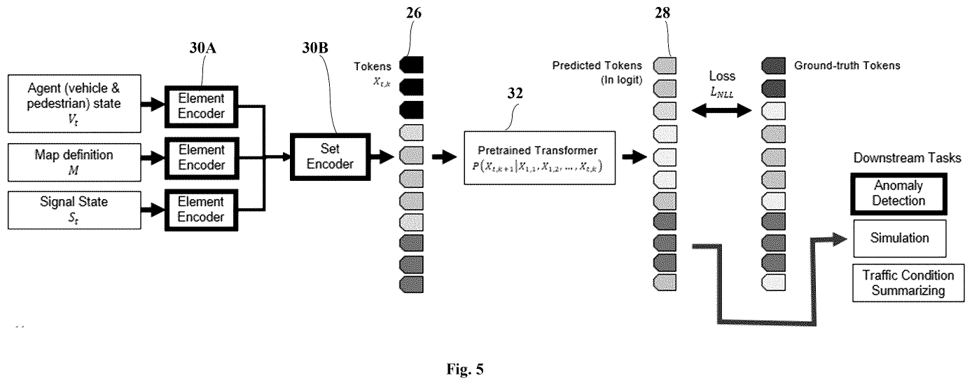

As shown in FIG. 5, to facilitate the states of participants/elements in the traffic scene 10, token encoders comprising the one or more element encoders 30A and the set encoder 30B are used to encode the states of the traffic scene 10 for the decoder-only transformer 32 to use. The objective of the GPT 20 is to predict the next state (next token) as accurately as possible. The ground-truth tokens comprise a shifted token sequence which may comprise the tokens for the traffic scene states in the time step preceding the current time step. A benefit of this is that no labelling is needed to train the GPT 20.

Referring again to FIG. 1, to circumvent the circular dependency on Vₜ₊₁ and Eₜ₊₁, the set tokenization techniques described with respect to FIG. 3 and preferably FIG. 4 are utilized. The set of agents' states and environment states is represented as a fixed-length sequence of latent tokens. A “latent token” refers to a discrete representation of information within a latent space to capture complex relationships without directly representing the original data.

Letting Xₜ denote the joint latent token set that represents the entire traffic state at time t:

$${X}_{t} = {\overline{V}}_{t} ⋃ {\overline{E}}_{t}$$

where V̅ₜ= [symbol] (Vₜ)∈ [symbol] ^{K}^{₁} and Ēₜ= [symbol] (Eₜ)∈ [symbol] ^{K}^{₂} are the token sets derived from the agent states and the environment states respectively, using a tokenization function [symbol] , a permutation-invariant set encoder satisfying Deep Sets theorem.

Letting X_{t,k}∈ [symbol] be the k-th token at time t and the total number of tokens K_{Σ}=K₁+K₂, the time-space sequence of latent tokens is represented as:

$$X = \{ {X}_{t , k} \vert t = 1 , 2 ... τ ; k = 1 , 2 , ... {K}_{\sum } \} .$$

If the current token is X_{t,k} with k<K_{Σ}, the next token is X_{t,k+1}. If k=K_{Σ}, the next token is X_{t+1,1}, the first token of the next time step.

The GPT 20 is now reformulated as a next token prediction task given past tokens within the space sequence, while the flow is modeled as the sequence of state tokens over time:

$$P ( {X}_{t , k + 1} \vert {X}_{1 , 1} , {X}_{1 , 2} , ... , {X}_{t , k} )$$

where X_{t,k+1} is the next token after X_{t,k} in the sequence. If k=K_{Σ}, then X_{t,k+1} refers to X_{t+1,1}.

The training objective of the GPT 20 is to minimize the negative likelihood of the observed token sequence X given the model parameters θ:

$${L}_{NLL} = - {\sum }_{t = 1}^{τ} {\sum }_{k = 1}^{{K}_{\sum }} log {P}_{θ} ( {X}_{t , k + 1} \vert {X}_{1 , 1} , {X}_{1 , 2} , ... , {X}_{t , k} ) .$$

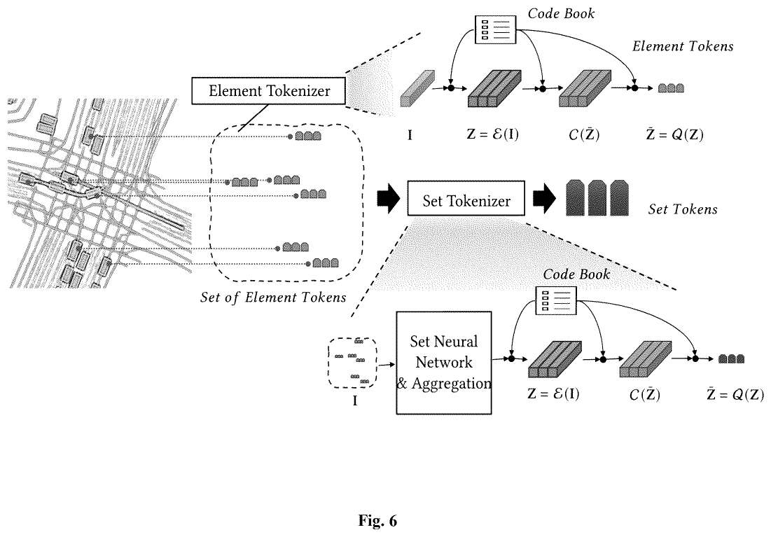

It will be understood that the states of many participants/elements in the traffic scene 10 are continuously changing. It is very challenging to encode a set of continuous-valued states rather than encoding one value state. To address this, the GPT 20 of the present invention preferably employs two stage tokenization as illustrated in FIGS. 4 and 5 and as further illustrated in FIG. 6. The tokenization process is divided into two stages. In a first stage, the states of elements are encoded into discrete tokens individually using the one or more element encoders 30A (FIGS. 4 and 5). Tokenization takes place on every individual element in the input set, turning them into tokens. Surrogate reconstruction is not needed at this stage as will be explained later.

In the second stage, the set of element tokens 34 is encoded into a fixed size discrete token 26 using the set encoder 30B. Tokenization takes place on the entire set of discrete tokens from the first stage. The second stage turns a reconstruction task into a simpler classification task, where the model predicts the tokens of the input set. Thus, element reconstruction loss becomes cross-entropy loss:

$${L}_{rec , ele ( stage 2 )} = - \frac{1}{{N}_{ele}} {\sum }_{i = 1}^{{N}_{ele}} {\sum }_{j = 1}^{K} ( {i}_{i , j} log ( {\hat{ι}}_{i , j} ) )$$

where i_{i,j} is the one-hot encoded ground truth token at position i, and î_{i,j} is the predicted probability of the token. The two-stage tokenization first computes a time series of multi-modality data into a time sequence of sets of element tokens 34, then computes the time sequence of sets of element tokens 34 into a time series of set tokens 26.

Two procedures are preferably employed to represent the set of agents' states and environment states of the traffic scene 10 as fixed-length sequence of discrete tokens to be fed into the flow model (transformer 32) of the GPT 20. These procedures comprise set encoding, as already described herein, and discrete token representation which involves vector quantization (VQ).

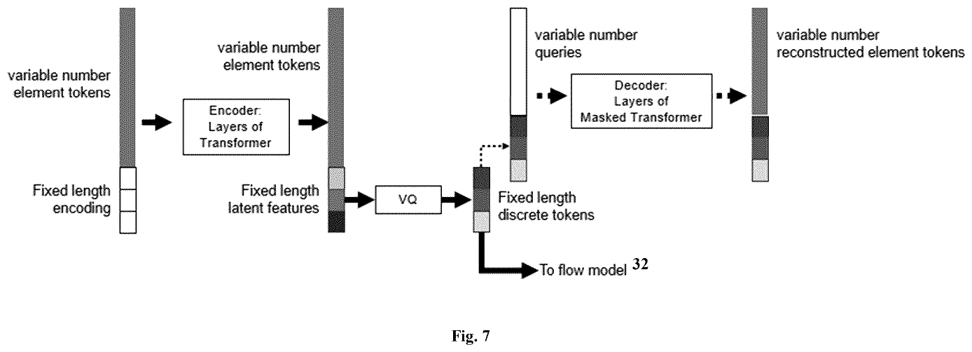

There are variable numbers of element states while the flow model (GPT 20) needs fixed, known size tokens to function well. Therefore, the set encoder 30B is used to map the variable-length unordered data of agents' states and environment states into fixed-length sequence of tokens as illustrated in FIG. 7.

The encoder layers of the transformer (FIG. 7), and, in particular, the attention function accepts arbitrary length sequences of inputs. A fixed known length of encoding is therefore appended into the variable-length sequence of element tokens (token set). After feeding the appended sequence into the encoder layers of the transformer, the information of the token set is populated into the encoding. Only the known-length encoding part is taken as the output latent feature. The latent feature will be mapped into fixed length discrete tokens in VQ for the flow model.

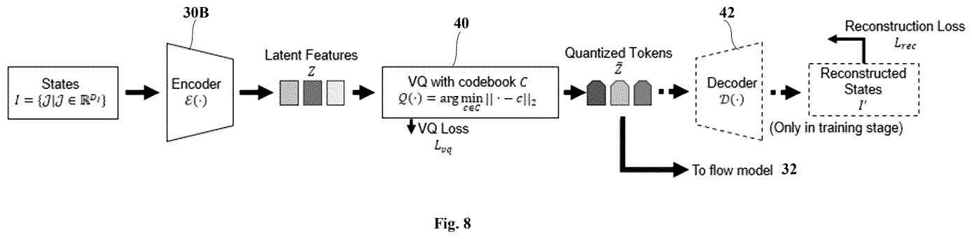

The GPT 20 works best with discrete tokens rather than continuous-valued states features. The Vector Quantized-Variational Autoencoder (VQ-VAE) 40 shown in FIG. 8 is good at learning discrete latent space, enabling the generation of compact token representations from high-dimensional continuous data, again as illustrated in FIG. 7.

The element encoder 30A is responsible for encoding individual input tokens before they enter the transformer layers of the transformer 32. This may include: token embeddings where each input token is mapped to a dense vector using a learned embedding matrix; and positional encoding where, since transformers lack inherent sequential awareness, a positional encoding (learned or sinusoidal) is added to token embeddings. The output of the element encoder 30A is a set of token embeddings, each representing a single input token with its position-aware encoding.

Once the individual token embeddings are created, they are passed through multiple self-attention layers in the transformer decoder of the GPT 20. The sequence of token embeddings is treated as a set of elements, and self-attention is applied to extract relationships between tokens by the set encoder 30B. Masked Self-Attention ensures that each token attends only to previous tokens (causal attention), enabling autoregressive generation. Multi-head attention layers allow the model to capture dependencies across different parts of the sequence. The output of this process is a contextualized representation of each token, incorporating information from previous tokens in the sequence.

Therefore, each token from the element encoder 30A is represented using embeddings and positional encodings. The transformer 32 of the GPT 20 applies masked self-attention to contextualize token representations and extract contextual meaning. The model predicts the next token based on the processed sequence so far. The process repeats, generating text token by token. The set encoder (self-attention layers) allows efficient parallel processing during training.

Referring to FIG. 8, given an input set of states I={ [symbol] | [symbol] ∈ [symbol] ^{D}^{_{I}}} where [symbol] is the element state from any modality, the VQ-VAE 40 encodes I into discrete tokens Z̅∈ [symbol] ^{K}, where [symbol] ∈{1, 2, . . . , Γ} is the set of codebook indices and K is the predefined number of latent codes to represent the states.

The input set of states I is mapped by a permutation-invariant set encoder ε 30B into specifically K continuous latent variables Z∈ [symbol] ^{K×D}.

$$Z = ℰ ( I ) = \{ {z}_{1} , {z}_{2} , ... , {z}_{K} \}$$

The continuous latent variable Z is then quantized into discrete tokens using a codebook C∈ [symbol] ^{Γ×D} with a finite set of embeddings {c₁, c₂, . . . , c_{Γ}}. The quantization function [symbol] assigns each latent vector z to the nearest codebook vector.

$$\overline{z} = 𝒬 ( z ) = arg {min}_{c ∈ C} {‖ z - c ‖}_{2}$$

Thus, the quantized latent tokens Z̅{z̅₁, Z̅₂, . . . , z̅^{K}}.

This process from I to Z̅ is denoted as the set tokenization function [symbol] :{·|·∈ [symbol] ^{D}}→ [symbol] ^{K}:

$$\overline{Z} = ℱ ( I ) = 𝒬 ( Z ) = 𝒬 ( ℰ ( I ) ) .$$

The input set of states I is reconstructed from Z̅ with indices to embedding mapping [symbol] from codebook C and a decoder [symbol] :

$${I}^{′} = 𝒟 ( 𝒞 ( \overline{Z} ) ) .$$

In a decoder-only transformer, surrogate reconstruction serves to improve the model's efficiency, accuracy, and ability to generate coherent outputs. Surrogate reconstruction can be usefully applied in scenarios where the transformer 32 needs to approximate missing information, refine outputs, or improve computational efficiency. Surrogate reconstruction is preferably used in the training method embodiment of the invention.

It is hard to define the reconstruction objective the encoder optimizes for the variable-sized unordered set data. To do this, a fixed-size subset of states from the element set is randomly sampled for the model to reconstruct it, instead of using the entire set. The model learns the representation that approximates the true representation of the subset.

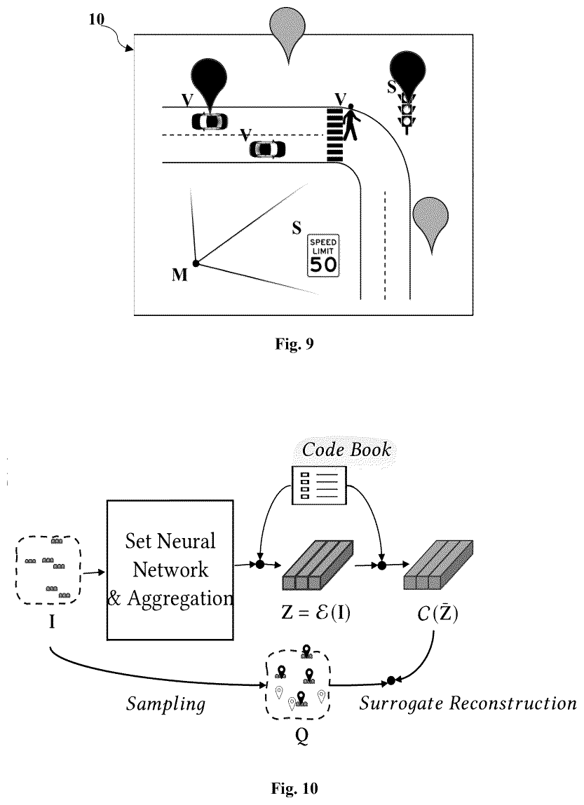

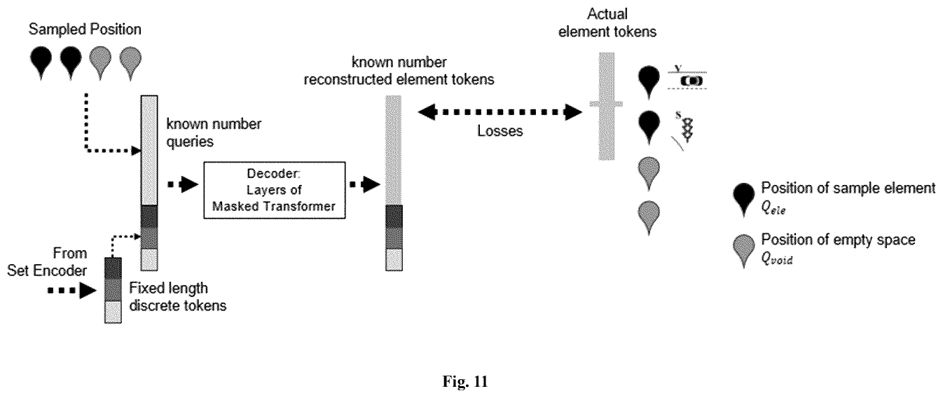

Referring to FIGS. 9 to 11, a fixed size subset of elements is sampled from the input space (traffic scene 10). Positions of the elements are used as the queries of the decoder. The decoder returns whether the position has an element and the token of that element if it exists. A trained decoder should be confident judging the presence of elements, and very accurate reconstructing the element tokens.

A subset of the input elements I is randomly sampled and their positions used as queries to the latent variables Z̅ from which the decoder [symbol] 42 (FIG. 8) reconstructs the sampled elements. The positions of the sampled elements is denoted as Qₑₗₑ={q₁, q₂, . . . q_{N}_{ₑₗₑ}}, where qᵢ∈ [symbol] ³ is the coordinate of the i-th sampled element and Nₑₗₑ is the number of sampled elements.

Another set of positions Q_{void}={p₁, p₂, . . . p_{N}_{_{void}}} is randomly sampled from empty space where no elements are present, where N_{void} is the number of sampled empty positions. Qₑₗₑ ensures reservations of information of the elements, and Q_{void} helps maintain the layout of the input set. The surrogate query set Q is defined as:

$$Q = {Q}_{ele} ⋃ {Q}_{void} .$$

The surrogate reconstruction set Iₛᵤᵣ′ is constructed by querying the latent variables Z̅ at the positions of Q:

$${I}_{sur}^{′} = 𝒟 ( \overline{Z} , Q ) .$$

This ensures the encoder ε 30B learns to encode fixed-length tokens from any variable-length input set, with Z̅ reserving the information of the original input set I regardless of its size.

The reconstruction loss of the model, given the surrogate querying strategy, consists of two components:

Element Reconstruction Loss: Assessing how well the model reconstructs the queried elements, this loss is defined as the mean squared error between elements:

$${L}_{rec , ele} = \frac{1}{{N}_{ele}} {\sum }_{i = 1}^{{N}_{ele}} {‖ {i}_{i} - {\hat{ι}}_{i} ‖}_{2}^{2}$$

where iᵢ is the i-th element in the sampled elements Iₑₗₑd, and \hat{ι}ᵢ is its reconstruction from

$${I}_{ele}^{′} ;$$

Presence Recognition Loss: This loss evaluates how accurately the model recognizes the presence or absence of elements at any position, and defined as the binary cross-entropy loss:

$${L}_{rec , pres} = - \frac{1}{N} {\sum }_{i = 1}^{N} ( {P}_{i} log ( {\hat{P}}_{i} ) + ( 1 - {P}_{i} ) log ( 1 - {\hat{P}}_{i} ) )$$

where Pᵢ is the ground truth label (1 for presence, 0 for absence) at position i, \hat{P}ᵢ is the predicted probability of presence, and N=Nₑₗₑ+N_{void} is the size of the surrogate query set Q.

The reconstruction loss is the weighted sum of these two components:

$${L}_{rec} = {L}_{rec , ele} + λ \cdot {L}_{rec , pres}$$

where λ is the weighted factor that balances the two loss components.

The quantization loss (VQ Loss) ensures that the latent vectors Z are efficiently mapped to the nearest codebook vectors in codebook C. This loss encourages the encoder to produce latent vectors that are close to the codebook vectors, as well as the codebook vectors to be representative of the latent space. The loss is defined as:

$${L}_{vq} = {‖ sg [ 𝒞 ( \overline{Z} ) ] - Z ‖}_{2}^{2} + β {‖ 𝒞 ( \overline{Z} ) - sg [ Z ] ‖}_{2}^{2}$$

where sg[·] denotes the stop-gradient operator that prevents gradients flowing through during back-propagation, and β is a hyperparameter that balances the two terms in the loss function.

The total training loss for the VQ-VAE is a weighted sum of the reconstruction loss and the quantization loss:

$$L = {L}_{rec} + α \cdot {L}_{vq}$$

where α is a weighting factor.

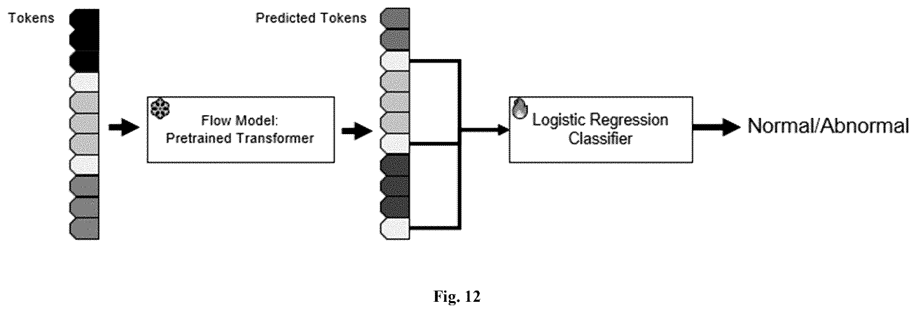

Referring to FIG. 12, anomaly detection is a useful function that can be implemented by the GPT 20. Anomaly detection on traffic flow refers to the identification of atypical traffic patterns. Such may indicate potential accidents, unexpected congestion, or unlawful driving.

A dataset of abnormal traffic scenarios is collected by manually introducing anomalies into the traffic environment in a CARLA™ simulator. The CARLA™ simulator is an urban autonomous driving simulator that is capable of simulating traffic scenes in 3D. It allows manual driving with other autonomous vehicles agents, and states and sensor data retrieval, c.f. https://carla.org/. The collected anomalies include sudden stops, illegal lane changes, wrong-way driving, running red lights, speeding, impeding traffic, driving on sidewalks, zigzagging, illegal turns, etc.

Embeddings are generated from a frozen pretrained flow model for each time step of the traffic scenarios. Only the embeddings corresponding to the end-of-time-step tokens are taken. A logistic regression classifier is then trained on these embeddings.

Data from abnormal traffic scenarios provides a labelled dataset for training the logistic regression classifier. The dataset comprises a plurality, e.g. 25, of distinct abnormal traffic samples, formally denoted as:

$${D}_{abnormal} = \{ {π}_{1} , {π}_{2} , ... , {π}_{N} \} .$$

Correspondingly an equal number of normal traffic scenarios are collected from typical driving simulations, represented as:

$${D}_{normal} = \{ {ρ}_{1} , {ρ}_{2} , ... {ρ}_{N} \} .$$

A leave-one-out-cross-validation (LOOCV) strategy is employed to rigorously assess the model's performance. Each scenario is sequentially excluded from the training set and used as a test set, while the remaining contribute to the training of the logistic regression classifier.

It has been found that the model comprising the GPT 20 of the invention outperforms other state-of-the-art traffic interaction models. In scenario-level average true positive rate (Avg-TPR), the model of the invention significantly outperform known models.

The flow model of the invention has the following strengths in handling anomaly detection:

Long Temporal Context: the model captures the temporal dynamics of traffic flow in an interval of, for example, over 20 seconds long, while known methods focus on shorter time frames of 1-2 seconds or individual frames. Longer temporal context enables detection of anomalies like traffic jams as well as other continual and complex patterns.

Multi-modal Data Interaction: the model incorporates diverse traffic data modalities in microscopic level, including agent trajectories, traffic signals, and map data, which constitute a complete smart traffic system. For example, the model can detect red-light violations by analyzing the interaction between agents and traffic signals.

Multi-agent Interaction: Traditional models often simplify the problem by treating agents independently or using aggregated metrics, which can overlook complex behaviors emerging from interactions, such as coordinated stops or lane changes that may signal anomalies.

Zero-shot Detection: the model is frozen and kept intact. This means the flow model achieves zero-shot learning and largely increases training efficiency when adopting downstream tasks.

The method also provides a method of training a GPT for processing road traffic data, using: a two-stage element tokenization process to convert the multi-modality traffic data into set tokens; or using a set encoder to convert a set of element tokens into a set token using a surrogate reconstruction process.

In the case of using a surrogate reconstruction process, the method comprises: randomly sampling a fixed subset of states of participants from the traffic scene; randomly sampling a fixed subset of empty space in the traffic scene where no participants are present; and using the random samples to determine the fixed length of the set token.

The invention also provides a non-transitory computer-readable medium storing machine-readable instructions, wherein, when the machine-readable instructions are executed by a processor, they configure the processor to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A method of processing road traffic data using a generative pre-trained transformer (GPT), the method comprising:
receiving a set of input tensors as an input to the GPT, each input tensor comprising multi-modality traffic data for one or more participants of a traffic scene, the GPT having been pre-trained on multi-modality traffic data;
the GPT computing traffic features of the traffic scene based on observed traffic states; and
the GPT predicting one or more future traffic states from the computed traffic features.

2. The method of claim 1, wherein the one or more participants of the traffic scene comprise any one or any combination of: vehicles within the traffic scene; pedestrians within the traffic scene; and traffic signals within the traffic scene.

3. The method of claim 2, wherein the multi-modality traffic data comprises any of: states of the traffic signals within the traffic scene; speed of vehicles and/or pedestrians within the traffic scene; trajectory of vehicles and/or pedestrians within the traffic scene; and information describing road network parameters of the traffic scene.

4. The method of claim 3, wherein the road network parameters of the traffic scene include information describing any of: lane layout of the traffic scene; and traffic rules of the traffic scene.

5. The method of claim 1, wherein the GPT employs one or more element encoders which converts the multi-modality traffic data into element tokens.

6. The method of claim 5, wherein the GPT employs a set encoder for converting a set of element tokens into a set token of fixed length.

7. The method of claim 6, wherein the GPT employs a decoder-only transformer which determines a next token from a sequence of set tokens, the next token comprising a predicted future traffic state for one of the participants of the traffic scene.

8. The method of claim 5, wherein the computed traffic features of the traffic scene comprise a time series of sets of element tokens converted from the multi-modality traffic data by the one or more element encoders.

9. A computer-implemented system for predicting future traffic states for one or more participants of a traffic scene, the system comprising:
an input for receiving a set of input tensors to the GPT, each input tensor comprising multi-modality traffic data for one or more participants of the traffic scene,
wherein the GPT is pre-trained on multi-modality traffic data and the GPT is configured to compute traffic features of the traffic scene based on observed traffic states of the traffic scene and to predict one or more future traffic states from the computed traffic features.

10. The system of claim 9, wherein the GPT comprises one or more element encoders which converts the multi-modality traffic data into element tokens.

11. The system of claim 10, wherein the GPT comprises a set encoder for converting a set of element tokens into a set token of predetermined and fixed length.

12. The system of claim 11, wherein the GPT comprises a decoder-only transformer which determines a next token from a sequence of set tokens, the next token comprising a predicted future traffic state for one of the participants of the traffic scene.

13. The system of claim 12, wherein the system is configured to use one or more next tokens to perform any of: anomaly detection; traffic simulation; and traffic condition summarizing.

14. The system of claim 13, wherein the system is configured to perform anomaly detection by detecting an abnormal traffic scenario from the one or more next tokens.

15. The system of claim 13, wherein the system comprises a logistic regression classifier for detecting an abnormal traffic scenario from the one or more next tokens.

16. A method of training a generative pre-trained transformer (GPT) for processing road traffic data, the GPT comprising an input for receiving a set of input tensors to the GPT, each input tensor comprising multi-modality traffic data for one or more participants of the traffic scene, the GPT being configured to compute traffic features of the traffic scene based on observed traffic states of the traffic scene and to predict one or more future traffic states from the computed traffic features, the training method using:
a two-stage element tokenization process to convert the multi-modality traffic data into set tokens; or
using a set encoder to convert a set of element tokens into a set token using a surrogate reconstruction process.

17. The method of claim 16, wherein the two-stage element tokenization process comprises:
employing one or more element encoders to convert the multi-modality traffic data into element tokens; and
employing a set encoder to convert a set of element tokens into a set token of predetermined and fixed length.

18. The method of claim 17, wherein the two-stage element tokenization process first computes a time series of multi-modality data into a time sequence of sets of element tokens, then computes the time sequence of sets of element tokens into a time series of set tokens.

19. The method of claim 16, wherein using a set encoder to convert a set of element tokens into a set token of fixed length using a surrogate reconstruction process comprises:
randomly sampling a fixed subset of states of participants from the traffic scene;
randomly sampling a fixed subset of empty space in the traffic scene where no participants are present; and
using the random samples to determine the fixed length of the set token.
